(19) United States
(12) Patent Application Publication
(10) Pub. No.: US 2003/0233545 A1
(43) Pub. Date: Dec. 18, 2003

(54) Diagnostic method for security records in networking application

(76) Inventors: Avigdor Eldar, Jerusalem (IL); Fabian Trumper, Jerusalem (IL); Zvi Vlodavsky, Mevaseret-Zion (IL); Ariel Rosenblatt, Montreal, CA (US)

Correspondence Address: KENYON & KENYON, 1500 K STREET, N.W., SUITE 700, WASHINGTON, DC, 20005, US

(21) Appl. No.: 10/167,476

(22) Filed: Jun. 13, 2002

(51) Int. Cl. H04L 9/00

(52) U.S. Cl. 713/168

(57) ABSTRACT

A diagnostic technique is disclosed for use in high-load, low-latency communication systems involving encrypted communications. During diagnostic operation, an encryption engine is placed in an offline mode to determine whether security records stored by the engine have been corrupted. In the offline mode, the encryption engine is provided with test data to be either encrypted or decrypted. The encryption engine processes the test data using the same algorithms and the same security records that would be used if it were operating on any other data in an online mode. The encryption engine then returns the processed data to its source. At the source, the processed data is compared to data that should have been generated if the encryption engine were using a correct security record. If they do not match, the security record is identified as corrupted.

### BACKGROUND

The present invention relates to a diagnostic method for use in integrated circuits.

Security records are data records that define the manner in which networking circuits perform authentication, encryption and decryption operations. In some computing applications, it is beneficial for a processing terminal (a server, desktop computer or other computing device) to include an integrated circuit or chipset dedicated to communication functions. Herein, this dedicated circuitry is called a “networking circuit.” Providing dedicated circuitry to support communication functions can free other processor circuits to perform higher level functionality, such as application execution.

The networking circuit uses a stored security record to authenticate, encrypt or decrypt data. Currently, most networking circuits do not permit higher layer applications to access the security record for diagnostic purposes. Although a higher level application can write new security records to networking circuits, currently it is not possible for an application to read a security record to confirm that the security record has not been corrupted. It is possible, therefore, that some error can either prevent a new security record from being stored in the networking circuit or may cause a properly stored security record to become corrupted. If a security record is prevented from being stored, then it is possible that secure data will be transmitted without encryption. If a security record becomes corrupted, then encrypted data cannot be recovered through a decryption operation. Neither case is satisfactory.

Accordingly, there is a need in the art for a diagnostic technique for use with a networking circuit that can confirm the integrity of previously stored security records.

### BRIEF DESCRIPTION OF THE DRAWINGS

FIG. 1 is a block diagram of a communication system suitable for use with various embodiments of the present invention.

FIG. 2 is a high-level block diagram of a networking circuit according to an embodiment of the present invention.

FIG. 3 is a flow diagram of a method according to an embodiment of the present invention.

FIG. 4 illustrates a communication flow that may occur during operation of the foregoing embodiments.

FIG. 5 illustrates another communication flow that may occur during operation of the foregoing embodiments.

FIG. 6 illustrates a security record management method according to an embodiment of the present invention.

### DETAILED DESCRIPTION

Embodiments of the present invention provide a diagnostic technique for use in high-load, low-latency communication systems involving encrypted communications. According to an embodiment, an encryption engine is placed in an offline mode to determine whether security records stored by the engine have been corrupted. In the offline mode, the encryption engine is provided with test data to be either encrypted or decrypted. The encryption engine processes the test data using the same algorithms and the same security records that would be used if it were operating on any other data in an online mode. The encryption engine then returns the processed data to its source. At the source, the processed data is compared to data that should have been generated if the encryption engine were using a correct security record. If they do not match, the security record is identified as corrupted.

FIG. 1 is a block diagram of a communication system 100 suitable for use with various embodiments of the present invention. In this system, several terminals 110-140 may be provided in mutual communication by a network 150. The terminals 110-140 may be fixed or mobile and may communicate via wired or wireless techniques. A variety of communication protocols have been defined for each of these techniques to provide communication among these terminals. Embodiments of the present invention are suitable for use with any of these techniques and protocols.

Terminal 110 is illustrated as a server having a dedicated networking integrated circuit 160 and other processing apparatus 170. In many computing applications, it is beneficial to execute applications and perform other high-load computing processes on a server, which may have more powerful processing capabilities than would be present in a laptop computer 120 or conventional desktop computer 120. Conventionally, servers 110 often are engaged in high-load transactions between multiple other terminals simultaneously. A networking circuit 160 within the server 110 is provided to manage high-data rate connections with the various other terminals 120-140. Doing so frees the remaining processing resources 170 of the server 110 for other tasks such as execution of applications. Often, there is a need to ensure that the communication is conducted with as little latency (delay) as possible in the delivery of data back and forth among the terminals. Further, there often is a need to increase data throughput as it is communicated among the terminals. Thus, processing-intensive operations for communication—such as encryption of data—may be performed by a dedicated circuit such as the networking circuit 160, rather than by a main server processor (not shown in FIG. 1).

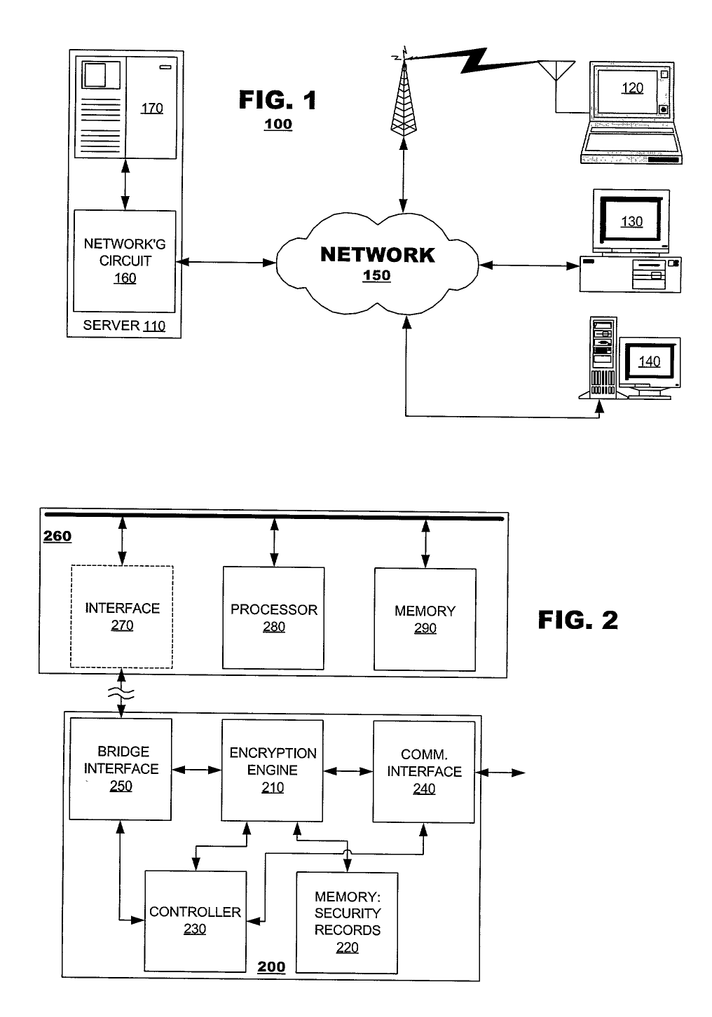

FIG. 2 is a high-level block diagram of a networking circuit 200 according to an embodiment of the present invention. The networking circuit 200 may include an encryption engine 210, a memory 220 to store security records, a controller 230, a communication interface 240 and a bridge interface 250. The encryption engine 210 encrypts data from some source within the server 110 for communication through the network 150 and decrypts encrypted data received therefrom. In performing the encryption/decryption functions, the encryption engine 210 retrieves security records from the memory 220. The memory 220 may be a non-volatile memory such as a ROM, EEPROM, flash memory or battery-backed RAM memory to permit the security records to persist even when the networking circuit 200 is unpowered. Ordinary volatile memory is appropriate if persistence is not required. The controller 230 defines operating parameters of the encryption engine 210.

The bridge interface 250 exchanges data with other processing elements 260 within the server. Thus the bridge interface 250 receives data from the other processing elements 260 to be encrypted and transmitted through the network (FIG. 1, 150). The bridge interface 250 also receives decrypted data from the encryption engine 210 and transfers it to other processing elements 260 of the server.

The processing elements 260 may execute program instructions that cause it to operate as a driver to the networking circuit 200. Thus, the processing elements 260 may include a bridge interface 270, one or more processors 280 and a memory system 290. The bridge interfaces 250, 270 of the networking circuit 200 and the processing elements 260 need not be provided in direct communication; oftentimes, they may communicate with each other via interstitial communication buses (not shown in FIG. 2). The driver 260 may send commands to the controller 230 of the networking circuit 200 to configure the circuit's operation. It also may transfer security records to the networking circuit 200 for storage in the memory 220.

In an embodiment, the encryption engine 210, the memory 220, the controller 230 and the bridge interface 250 may be provided as a single integrated circuit or chipset.

The communication interface 240 generates communication signals for delivery to the network (FIG. 1, 150) and captures signals delivered to it therefrom. The communication interface 240 typically decodes captured signals and renders a binary data stream therefrom for decryption and other processing by the encryption engine 210.

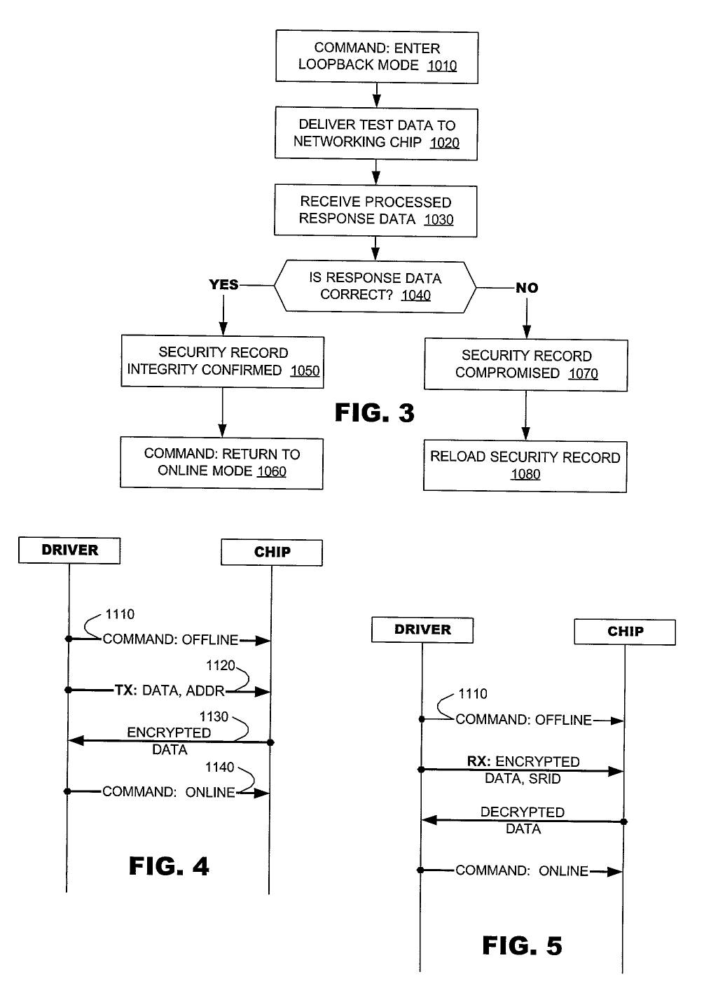

FIG. 3 is a flow diagram of a method 1000 according to an embodiment of the present invention. This method may become operable when it is desired to confirm the integrity of security record data stored by the networking circuit 200 (FIG. 2). According to the method 1000, the driver 260 may place the networking circuit in a ‘loopback’ mode (block 1010). Thereafter, the driver 260 may transfer test data to the networking circuit 200 and cause it to process the test data according to the same algorithms as are applied by the networking circuit 200 during its normal operating mode (block 1020). Thereafter, the encryption engine 210 returns the processed data to the driver 260 in a response (block 1030).

The driver 260 may store its own copy of the security record stored at the networking circuit 200. Thus, it can apply the identical processing that was to be used by the networking circuit 200. The driver 260 does so and compares its results to the response data returned from the networking circuit 200 to determine whether the response data is correct (block 1040). If the response data is correct, the driver 260 confirms the integrity of the security record at the networking circuit (block 1050). Thereafter, the driver 260 may return the networking circuit to a normal mode of operation (block 1060).

If the response data is incorrect, however, the driver 260 identifies the security record as compromised (block 1070). Several responses are possible when a corrupt security record has been detected. In a first embodiment, the driver may attempt to overwrite the corrupted security record in the memory (block 1080). Thereafter, the method 1000 may be repeated to confirm that the valid security record was stored successfully by the memory. Alternatively, the corrupt security record may be flagged as unusable due to the corruption. This alternative may be useful if prior attempts to overwrite a corrupt security record with a valid one were unsuccessful, such as when the memory location that stores the security record is flawed. Other alternatives may resort to use of alarms or other indicators to support personnel indicating an error condition with the networking circuit.

The foregoing method 100 has been described as testing a single security record within the networking circuit 200. Of course, since the networking circuit 200 may store several security records, it may be appropriate to perform the method 1000 over multiple iterations to test each of the security records stored therein or to test a plural number of security records desired.

In the loopback mode, the networking circuit 200 does not exchange data with the network 150 (FIG. 1). It receives data from a processing element 260 within the server, processes it either through encryption or decryption, and returns processed data to its source. The networking circuit 200 determines which operation to perform—encryption or decryption—in response to a command from the processing element 260.

Conventionally, during normal encryption or decryption operations, the networking circuit may select one of many stored security records to use in response to information received in the data stream to be processed. Typically, a data stream will include an express identifier of the security record, by address or other identifier. Alternatively, the data stream will include network addresses in source or destination fields of the data stream; security records may be associated with these network addresses. Other, more secure methods of identifying security records may be used. For example, in the known IP Security Protocol (IPSEC), a triple is provided in an IPSEC frame that identifies a destination IP address, a type of IPSEC protocol used to encode the packet and a security protocol index. See, Kent, et al., “Security Architecture for the Internet Protocol,” RFC 2401 (available at: http://www.ietf.org/rfc/rfc2401.txt?number=2401). In an embodiment, when performing the method 1000 of FIG. 3, the driver 260 may use these same identifiers to identify which of the security records the networking circuit 200 is to use during the loopback test.

FIG. 4 illustrates a communication flow that may occur during operation of the foregoing embodiments. As illustrated, the driver provides a command to enter the offline mode (communication 1110). The driver then provides test data to the networking circuit indicative of data to be transmitted through the network (communication 1120). The networking circuit encrypts the data and returns encrypted data to the driver (communication 1130). In this embodiment, the security record to be used during encryption is identified by the network address of the identified destination. If a comparison between locally generated encrypted data and the encrypted data generated by the networking circuit indicates a match, the driver returns the networking circuit to an online state (communication 1140).

FIG. 5 illustrates another communication flow that may occur during operation of the foregoing embodiments. In this embodiment, the driver provides a command to enter the offline mode (communication 1210). The driver provides test data to the networking circuit mimicking data “received” from the network 150 (communication 1220). In this embodiment, the driver identifies the security record by an express identifier (SRID). The networking circuit retrieves the security record, decrypts the test data using the security record and provides decrypted data to the driver in a response (communication 1230). Thereafter, if the driver determines that the decryption was performed correctly, the driver may return the networking circuit to the online state (communication 1240).

The foregoing embodiments have described the security record as a basis for performing encryption. While it certainly can be used for such applications, it is not so limited. Embodiments of the present invention also find application in networking circuits that perform data authentication operations. In such embodiments, a security record may identify authentication algorithms and store keys for use with such algorithms. The loopback test may provide test data that is known either pass or fail an authentication test of one or more algorithms. Thus, by examining processed test data returned by the networking circuit, the integrity of a security record may be validated.

Of course, the foregoing embodiments find application in systems in which a security record identifies a combination of encryption and authentication algorithms.

The foregoing embodiments are useful to distinguish between communication faults that may occur because of corrupt security records and communication faults from other sources. As noted, conventional networking circuits do not have diagnostic apparatus to identify when security records are and are not properly stored. Memory errors in the networking circuit may prevent the circuit from storing a security record properly when the driver initially stores the security record at the networking circuit. In this case, without the benefits of the present invention, a networking circuit may fail to encrypt data prior to delivery to the network. The data would be exposed in this case. However, using the benefits of the foregoing embodiments, a driver may confirm the validity of a security record immediately after storing it at the networking circuit. Any errors in storage may be detected before a transmission of sensitive data would be attempted. Similarly, the loopback test may be performed to confirm that an attempt to delete a security record was successful and the security record is, in fact, deleted.

Of course, it also is useful to detect events where abnormal activity occurs even though the security record is valid. In encrypted communication, encryption/decryption failures can occur due to security record corruption but they also can occur when a “stranger” attempts to gain access to secure data without authorization.

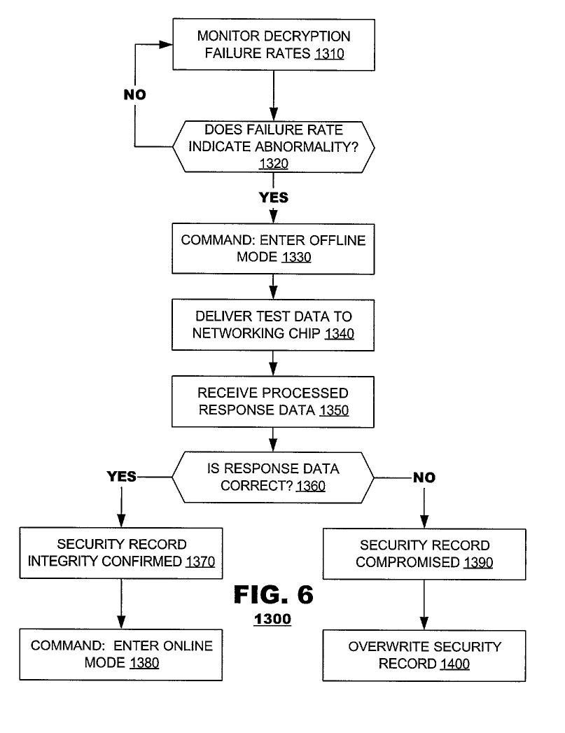

FIG. 6 illustrates a security record management method 1300 according to an embodiment of the present invention. According to this method 1300, a server may monitor communication failure rates on a predetermined basis (block 1310). From time to time, the failure rates may have characteristics that are indicative of a processing abnormality (block 1320). For example, if communication failure rates rise above a predetermined threshold or if they exhibit certain bursty properties, it may be appropriate to confirm the integrity of one or more security records. In this case, the server may command the networking circuit to enter the offline state (block 1330), provide it with test data (block 1340) and observe the networking circuit's response (block 1350). If the response data matches expected response data (block 1360), the server confirms the integrity of the security record (block 1370) and returns the networking circuit to normal operation (block 1380). Of course, the failure rates may be generated from other communication fault or may be generated due to some type of external attack upon the server. Thus, following block 1380, the server may continue with other diagnostic operations beyond the scope of this discussion.

If it is determined that the security record is corrupt (block 1390), the server may attempt to overwrite the corrupt security record with a valid security record (block 1400). If this is successful, the server may return the networking circuit to normal operation.

The foregoing embodiments are useful to protect a terminal against a type of external attack, known colloquially as “denial of service” attacks. In this type of attack, a stranger transfers massive quantities of garbage data to a server. The denial of service occurs when a server attempts to decode the garbage data at the expense of valid data. Denial of service attacks, in addition to consuming processing resources and bandwidth of a terminal, can further impede progress of terminal operation by causing it to enter a number of diagnostic routines when severe communication failures are detected. For example, without the benefits of the foregoing embodiments, if high communication failure rates were detected, one might propose to overwrite a security record without first checking to see if it had been corrupted. The process of taking a networking chip offline and writing new security records to it consumes a great deal of time—more time than is required to send test data to the networking circuit and observe its response—and actually would contribute to the denial of service phenomenon. Additional server resources would be spent overwriting valid data; these resources otherwise could be spent processing valid communication.

The foregoing embodiments have been described in the context of a networking circuit provided as part of networking server 110 (FIG. 1). Of course, the principles of the present invention are not so limited. Networking circuits find application in terminals of various types, including the terminals 120-140 shown in FIG. 1. Additionally, the foregoing embodiments may be used in a switch, a gateway, router, bridge, an embedded device or other network device. Indeed, embodiments of the present invention find application in any networking circuit in which encryption techniques are to be used.

Throughout this discussion, multiple references have been made to “security records” delivered to and stored by networking circuits. Security records are well-known data records that define how authentication, encryption and decryption operations shall be performed. While the structure of security records may vary depending upon implementation, a security record typically includes, for example, a key or key pair to be used during encryption and decryption operations, an identifier of an authentication, encryption or decryption algorithm for which the key/key pair is to be used and, optionally, additional administrative data relating to the security record. For example, a security record may include an indicator identifying an expiration time for the security record, beyond which the security record should not be used. The security record also includes association data to permit it to be identified by a governing protocol.

Several embodiments of the present invention are specifically illustrated and described herein. However, it will be appreciated that modifications and variations of the present invention are covered by the above teachings and within the purview of the appended claims without departing from the spirit and intended scope of the invention.

We claim:

1. A diagnostic method for a security record, comprising:
causing the networking circuit to enter a loopback mode,
providing test data to the networking circuit,
receiving processed test data from the networking circuit,
comparing the processed test data to an expectation of the processed test data, and
if they match, confirming integrity of the security record.

2. The diagnostic method of claim 1, further comprising, at the networking circuit, processing the test data in the loopback mode according to a same algorithm that would be applied to test data in a normal operating mode if received from a communication network.

3. The diagnostic method of claim 1, further comprising returning the networking circuit to a normal operating mode.

4. The diagnostic method of claim 1, further comprising, if they do not match, storing a new copy of the security record at the networking circuit.

5. The diagnostic method of claim 4, further comprising, following the storing, repeating the method to determine if the new copy was stored properly.

6. The diagnostic method of claim 1, wherein the expectation of the processed test data is encrypted test data.

7. The diagnostic method of claim 1, wherein the expectation of the processed test data is decrypted test data.

8. The diagnostic method of claim 1, wherein the providing includes providing a security record identifier along with the test data.

9. The diagnostic method of claim 1, wherein the providing includes providing network addresses along with the test data.

10. The diagnostic method of claim 1, wherein the providing includes a destination address, an indicator of an encryption algorithm to use during processing of the test data, and a securing protocol index.

11. The diagnostic method of claim 10, wherein the destination address, algorithm indicator and security protocol index are provided in accordance with the IPSEC protocol.

12. The diagnostic method of claim 1, wherein the security record includes an identifier of an authentication algorithm and an associated key.

13. A diagnostic method, comprising:
monitoring communication failure rates at a terminal,
when communication failure rates indicate a possible abnormality, causing a networking circuit of the terminal to enter an offline state,
providing test data to the networking circuit,
receiving processed test data from the networking circuit,
comparing the processed test data to expected processed test data, the expected processed test data having been generated with reference to a security record, and
if they match, returning the networking circuit to an online state.

14. The diagnostic method of claim 13, further comprising, at the networking circuit, processing the test data in the offline state according to a same algorithm that would be applied to test data in the online state if received from a communication network.

15. The diagnostic method of claim 13, further comprising, if they do not match, storing a new copy of the security record at the networking circuit.

16. The diagnostic method of claim 15, further comprising, following the storing, repeating the method to determine if the new copy was stored properly.

17. The diagnostic method of claim 13, wherein the expected processed test data is encrypted test data.

18. The diagnostic method of claim 13, wherein the expected processed test data is decrypted test data.

19. The diagnostic method of claim 13, wherein the providing includes providing a security record identifier along with the test data.

20. The diagnostic method of claim 13, wherein the providing includes providing network addresses along with the test data.

21. A terminal, comprising:
a networking circuit to support the terminal's communication with a network, comprising:
an encryption engine,
a memory to store security records,
an interface to the network,
a processing element provided to source data to the networking circuit,
a driver, to confirm proper operating of the networking circuit by:
providing test data to the networking circuit,
receiving processed test data from the networking circuit,
comparing the processed test data to an expectation of the processed test data.

22. The terminal of claim 21, wherein the terminal is a server.

23. The terminal of claim 21, wherein the terminal is a gateway.

24. The terminal of claim 21, wherein the terminal is a communication switch.

25. The terminal of claim 21, wherein, when the processed test data does not match the expected processed test data, the driver causes a security record in the memory to be overwritten.

26. The terminal of claim 21, wherein an encryption engine and the memory are part of a single integrated circuit.

27. The terminal of claim 21, wherein the memory is a non-volatile memory.

28. A computer readable medium storing program instructions that, when executed, cause to be performed a method, comprising:
causing a networking circuit to enter a loopback mode,
providing test data to the networking circuit,
receiving processed test data from the networking circuit,
comparing the processed test data to expected processed test data, and
if they match, confirming integrity of the security record.

29. The medium of claim 28, wherein the method further comprises returning the networking circuit to a normal operating mode.

30. The medium of claim 28, wherein the method further comprises, if the processed data and the expected processed test data do not match, storing a new copy of the security record at the networking circuit.

31. The medium of claim 30, wherein the method further comprises further comprising, following the storing, repeating the method to determine if the new copy was stored properly.

32. The medium of claim 28, wherein the expected processed test data is encrypted test data.

33. The medium of claim 28, wherein the expected processed test data is decrypted test data.

34. A method of storing a new security record in a networking circuit, comprising:
commanding the networking circuit to store the new security record,
commanding the networking circuit to process test data with reference to the new security record,
comparing processed test data with expected processed test data, and
confirming the storing if the processed test data and the expected processed test data match.

35. The diagnostic method of claim 34, further comprising returning the networking circuit to a normal operating mode following the confirmation.

36. The diagnostic method of claim 34, further comprising, if they do not match, repeating the method.

37. The diagnostic method of claim 34, wherein the expected processed test data is encrypted test data.

38. The diagnostic method of claim 34, wherein the expected processed test data is decrypted test data.

39. The diagnostic method of claim 34, further comprising providing a security record identifier along with the command to process test data.

40. The diagnostic method of claim 34, further comprising providing network addresses along with the command to process test data.
